(19) United States
(12) Patent Application Publication
(10) Pub. No.: US 2008/0077752 A1
(43) Pub. Date: Mar. 27, 2008

(54) Storage system and audit log management method

(75) Inventor: Junji Kinoshita, Kawasaki (JP)

Correspondence Address: SUGHRUE MION, PLLC, 2100 PENNSYLVANIA AVENUE, N.W., SUITE 800, WASHINGTON, DC, 20037, US

(73) Assignee: HITACHI, LTD., Tokyo (JP)

(21) Appl. No.: 11/641,321

(22) Filed: Dec. 18, 2006

(30) Foreign Application Priority Data
Sep. 25, 2006 (JP) 2006-259316
Dec. 4, 2006 (JP) 2006-326765

(51) Int. Cl. G06F 13/00

(52) U.S. Cl. 711/154

(57) ABSTRACT

The present invention provides a storage system and an audit log management method that achieve the secure and highly-reliable collective storage of audit logs, making easy audit log operation and management possible.

A host apparatus sends audit log data for the host apparatus to a storage apparatus via a network, and the storage apparatus writes/reads the audit log data sent from the host apparatus to/from an audit log storage area, consisting of an area for storing audit log data, defined in one or more logical units. This makes it possible to achieve a storage system and an audit log management method that can collectively store audit log data in a secure and highly reliable manner, making audit log operation and management easy.

### CROSS-REFERENCE TO RELATED APPLICATIONS

This application relates to and claims priority from Japanese Patent Application No. 2006-259316, filed on Sep. 25, 2006, and Japanese Patent Application No. 2006-326765, filed on Dec. 4, 2006, the entire disclosure of which are incorporated herein by reference.

### BACKGROUND

1. Field of the Invention

The invention relates to a storage system and an audit log management method, and specifically relates to one that is suited for use in a storage system in which a storage apparatus, and host apparatuses, which are higher-level apparatuses, are connected via a network.

2. Description of Related Art

JP-A-2002-111667 discloses a conventional network system wherein logs of audit data output by devices in the system are used to find the causes for system failures or unauthorized access, etc., and take appropriate counter-measures. Here, an “audit log” refers to information indicating the occurrence of audit events designated in advance, such as device failures. Also, in recent years, audit logs have become increasingly important, as they are used by businesses and organizations for compliance with the laws and regulations and audit standards, various kinds of security evaluation standards, etc., or are submitted as evidence in lawsuits.

So, in conventional network systems, audit log data output by various kinds of devices, such as hosts, switches, or storage apparatuses (for example, disk array apparatuses) are collected on one log server (hereinafter referred to as “syslog server”) using a protocol called “syslog,” and monitoring the systems and finding the causes for failures or unauthorized access, etc., is conducted by correlation analysis of the audit logs for the devices, and the audit logs are collectively stored for audits or lawsuits.

Meanwhile, with the increase in the amount of data dealt with by businesses and organizations, storage consolidation using storage apparatuses is progressing. The storage apparatuses are connected to hosts via SANs (Storage Area Networks). Examples of the SAN include a FC-SAN using FC (Fibre Channel) protocol, and an IP-SAN using TCP/IP (transmission Control Protocol/Internet Protocol) and iSCSI (internet SCSI [Small Computer System Interface]) protocol.

Multiple logical volumes (hereinafter referred to as “logical unit(s)” from time to time) are defined in a storage apparatus, and hosts connected to the SAN write/read data to/from these logical units in the storage apparatus.

In a FC-SAN or IP-SAN, data is written/read to/from the logical units in a storage apparatus by data transfer using SCSI commands, and a host accesses the storage apparatus, designating the relevant logical unit and the location of the relevant data in that logical unit (hereinafter referred to as “logical address”).

The storage apparatus may also be connected to the hosts via a LAN (Local Area Network), and is used as a file server for sharing files between the hosts. In a LAN, data is written/read in files to/from the storage system by data transfer according to a network file system protocol, such as NFS (Network File System) or CIFS (Common Internet File System). In these cases, a host accesses the storage apparatus, designating the relevant file, where data is written to or read from, and the location of the relevant data in that file (hereinafter referred to as “offset address”).

### SUMMARY

As mentioned above, with the increase in the importance of audit logs, the amount of audit log data that should be collected and stored in storage apparatuses will also increase in the future. Accordingly, with the aforementioned related art, an increased load will be imposed on a network or log server transferring audit log data. As a method of distributing the load, dividing the network or log server into multiple networks or logs may be considered. However, with that method, the audit logs are distributed in those networks or log servers, and correlation analysis is difficult.

Moreover, since syslog is a simple protocol, audit log data may disappear on a transfer path, or the service may be disabled due to an attack by a transmission source using an assumed name sending a huge amount of audit log data to a log server. As businesses and organizations collect and store (manage) audit log data, the low reliability and security of syslog is a critical problem.

The present invention has been made in light of the above points, and has the objective of providing a storage system and an audit log management method that achieve the secure and highly-reliable collective storage of audit logs, making easy audit log operation and management possible.

In order to achieve the above objective, the present invention provides a storage system, including: one or more host apparatuses; and a storage apparatus connected to the one or more host apparatuses via a network, the storage apparatus including one or more connection ports for connecting, to the network, one or more logical units defined in a storage area for storing data received from the one or more host apparatuses via the network, wherein: a host apparatus, from among the one or more host apparatus, sends audit log data consisting of information indicating the occurrence of a predetermined audit event in the host apparatus to the storage apparatus via the network; and the storage apparatus writes/reads the audit log data sent by the host apparatus to/from an audit log storage area consisting of an storage area for storing audit log data, defined in a logical unit from among the one or more logical units.

Accordingly, this storage system makes it possible to collectively store the audit log data for the host apparatuses in the storage apparatus.

The present invention also provides an audit log management method for managing audit log data consisting of information indicating the occurrence of a predetermined event in a host apparatus from among one or more host apparatuses in a storage system connecting the one or more host apparatuses and a storage apparatus via a network; the method including: a first step of the host apparatus sending the audit log data for the host apparatus to the storage apparatus via the network; and a second step of the storage apparatus writing/reading the audit log data sent from the host apparatus to/from an audit log storage area, consisting of an area for storing audit log data, defined in one or more logical units.

Accordingly, this storage system makes it possible to collectively store the audit log data for the host apparatuses in the storage apparatus.

According to the present invention, the audit log data for host apparatuses can be collectively stored in a storage apparatus without using the protocol called “syslog,” making it possible to achieve a storage system and an audit log management method that can collectively store audit log data in a secure and highly reliable manner, making audit log operation and management easy.

Other aspects and advantages of the invention will be apparent from the following description and the appended claims.

### BRIEF DESCRIPTION OF THE DRAWINGS

FIG. 1 is a block diagram showing an example of the entire configuration of a storage system.

FIG. 2 is a block diagram showing an example of a program and data configuration.

FIGS. 3A to 3G are conceptual diagrams respectively showing the configuration of access request data, a command frame, an audit log management command, audit log data, and an audit log data body.

FIG. 4 is a conceptual diagram showing an example of the structure of a logical device information table.

FIG. 5 is a conceptual diagram showing an example of the structure of a cache management information table.

FIG. 6 is a conceptual diagram of an example of the structure of an audit log management information table.

FIG. 7 is a conceptual diagram of an example of the structure of an audit log control information table.

FIG. 8 is a conceptual diagram showing an example of the structure of an audit log access control information table.

FIG. 9A is a flowchart showing the procedure for first command processing.

FIG. 9B is a flowchart showing the procedure for first write command processing.

FIG. 9C is a flowchart showing the procedure for audit log addition processing.

FIG. 10A is a flowchart showing the procedure for second command processing.

FIG. 10B is a flowchart showing the procedure for second write command processing.

FIG. 10C is a flowchart showing the procedure for second read command processing.

FIG. 11 is a flowchart showing the procedure for audit log extraction service processing.

FIG. 12 is a flowchart showing the procedure for third command processing.

FIG. 13 is a flowchart showing the procedure for audit log write command processing.

FIG. 14 is a flowchart showing the procedure for fourth command processing.

### DETAILED DESCRIPTION OF PREFERRED EMBODIMENTS

An embodiment of the present invention will be described below with reference to the drawings.

### (1) First Embodiment

### (1-1) Configuration of a Storage System According to an Embodiment of the Present Invention

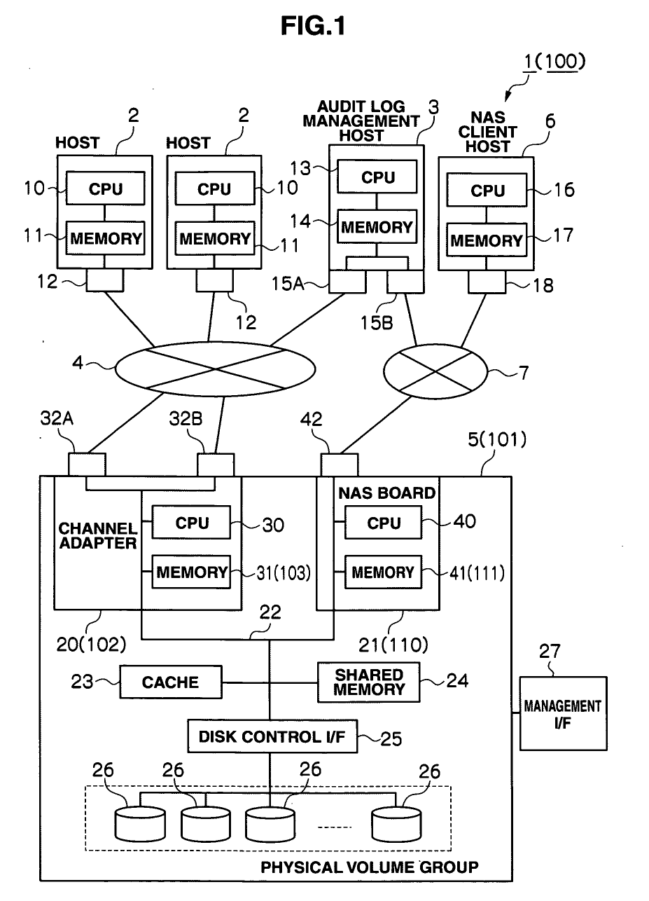

In FIG. 1, 1 denotes an entire storage system according to an embodiment of the present invention. This storage system 1 is configured by hosts 2 and an audit log management host 3 being connected to a storage apparatus 5 via a SAN 4, and the audit log management host 3 and a NAS (Network Access Server) client host 6 being connected to the storage apparatus 5 via a LAN 7.

The hosts 2 are computers that access data stored in the storage apparatus 5 via the SAN 4, and each include a CPU 10, memory 11, and a connection port 12. The CPU 10 is a processor that, for example, executes processing for inputting/outputting data to/from the storage apparatus 5. The memory 11 stores programs executed by the CPU 10, and data used for those programs. The connection port 12 is a network interface for connecting the relevant host 2 to the SAN 4.

The audit log management host 3 is a computer that accesses data stored in the storage apparatus 5 via the SAN 4 or the LAN 5, and includes a CPU 13, memory 14, and ports 15A, and 15B. The CPU 13 is a processor that, for example, executes processing for inputting/outputting data to/from the storage apparatus 5. The memory 14 stores programs executed by the CPU 13, and data used for these programs. The connection port 15A is a network interface for connecting the audit log management host 3 with the SAN 4, and the connection port 15B is a network interface for connecting the audit log management host 3 with the LAN 7.

The NAS client host 6 is a computer that accesses data stored in the storage apparatus 5 via the LAN 7, and includes a CPU 16, memory 17, and a connection port 18. The CPU 16 is a processor that, for example, executes the processing for inputting/outputting data to/from the storage apparatus 5. The memory 17 stores programs executed by the CPU 16, and data used for these programs. The connection port 18 is a network interface for connecting the NAS client host 6 with the LAN 7.

The SAN 4 may be a FC-SAN or IP-SAN. The communication between the hosts 2 and the storage apparatus 5 via the SAN 4, and the communication between the audit log management host 3 and the storage apparatus 5 via the SAN 4 is conducted according to SCSI protocol. The communication between the audit log management host 3 and the storage apparatus 5 via the LAN 7, and the communication between the NAS client host 6 and the storage apparatus 5 via the LAN is conducted according to a network file system protocol, such as NFS or CIFS protocol.

The storage apparatus 5 is what is called a disk array apparatus, and includes a channel adapter 20, a NAS board 21, an internal bus 22, cache memory 23, shared memory 24, a disk control interface 25, a plurality of physical volumes 26, and a management interface 27.

The channel adapter 20 and the NAS board 21 are connected to the cache memory 23 and the shared memory 24 via the internal bus 22, and also to the physical volumes 26 via the disk control interface 25. The cache memory 23 is used to temporarily store data to ensure efficient data transmission when the hosts 2, the audit log management host 3, or the NAS client host 6 access data stored in the storage apparatus 5. The shared memory 24 is used to, for example, store management information on data in the cache memory 23. The management interface 27 serves as an interface for the storage apparatus 5 administrator to perform management and operations relating to the storage apparatus 5 operation, such as the settings for the channel adapter 20 or the NAS board 21.

The channel adapter 20 provides a data input/output interface using SCSI protocol for communication between the hosts 2 and the audit log management host 3, and the storage apparatus 5 via the SAN 4. The channel adapter 20 includes a CPU 30, memory 31, and connection ports 32A and 32B. The CPU 30 is a processor that, for example, executes data input/output processing. The memory 31 stores programs executed by the CPU 30, and data used for these programs. The connection ports 32A and 32B are network interfaces for connecting the channel adapter 20 with the SAN 4.

The NAS board 21 has a function that provides a data input/output interface using a network file system protocol, such as NFS, or CIFS protocol, for communication between the audit log management host 3 and the NAS client host 6, and the storage apparatus 5 via the LAN 7. The NAS board 21 includes a CPU 40, memory 41, and a connection port 42. The CPU 40 is a processor that executes, for example, data input/output processing. The memory 41 stores programs executed by the CPU 40, and data used for these programs. The connection port 42 is a network interface for connecting the NAS board 21 with the LAN 7.

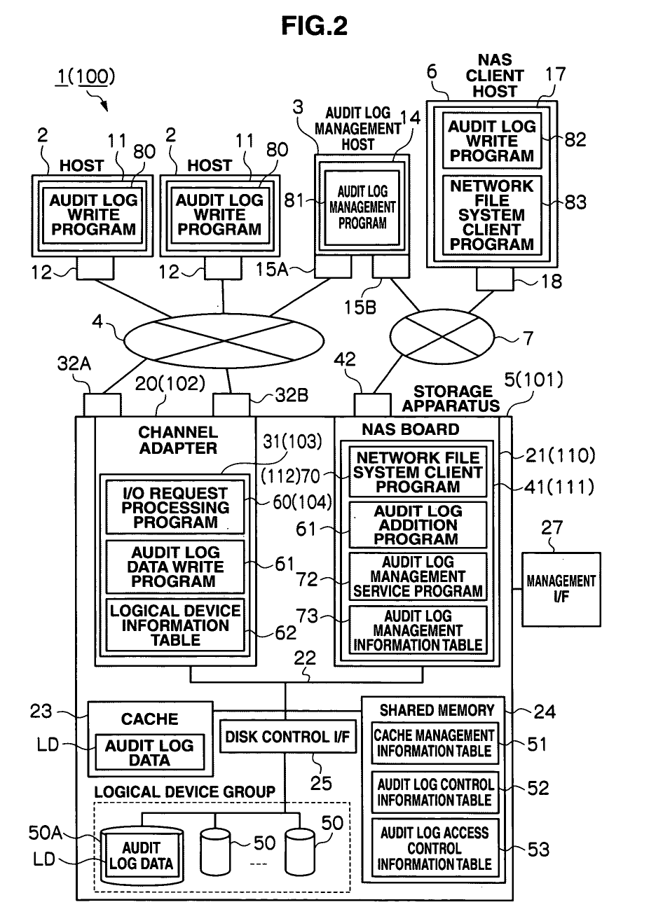

FIG. 2 shows an example of the logical configuration of the storage system 1. The storage apparatus 5 includes one or more logical devices 50, and at least one audit log dedicated device 50A, which is one of the logical devices 50. The storage apparatus 5 holds audit log data LD in the cache memory 23 to ensure efficient data transmission. The storage apparatus 5 also holds a cache management information table 51, an audit log control information table 52, and an audit log access control information table 53 in the shared memory 24.

The channel adapter 20 holds an I/O request processing program 60, an audit log addition program 61, and a logical device information table 62 in the memory 31. The NAS board 21 holds a network file system service program 70, an audit log addition program 61, and an audit log management service program 72, an audit log management information table 73 in the memory 41.

The hosts 2 stores an audit log write program 80 in the memory 11. The audit log management host 3 stores an audit log management program 81 in the memory 14. The NAS client host 6 holds an audit log write program 82 and a network file system client program 83 in the memory 17.

The logical devices 50 are those created by re-defining the physical volumes 26 in the storage apparatus 5. In the storage apparatus 5, the logical devices 50 are further re-defined as logical units so that the hosts 2 and the audit log management host 3 can recognize the logical devices 50 in terms of logical units.

Each of hosts 2 and the audit log management host 3, when sending a SCSI command to the channel adapter 20 via the SAN 4, designates the LUN (Logical Unit Number), which is a logical unit identifier, and the channel adapter 20 identifies the logical device 50 corresponding to the logical unit and perform data input/output.

In the storage apparatus 5, the NAS board 21 has a file system (hereinafter referred to as “local file system”) built in the logical devices 50, and manages data in the logical devices 50 on a file-by-file basis.

Furthermore, in the storage apparatus 5, the network file system service program 70 exports files in the local file system for file sharing, etc., using the network file system protocol.

The audit log management host 3 and the NAS client host 6 input/output data to/from the logical devices 50 via the network file system protocol.

The audit log management host 3 and the NAS client host 6, when sending a network file system protocol command to the NAS board 21 via the LAN 7, designates the name of the file exported by the network file system service program 70, and the NAS board 21 identifies the file in the local file system corresponding to the designated file name, and then identifies the logical device 50 associated with the file and inputs/outputs data to/from that logical device 50.

The logical devices 50 include at least one audit log dedicated device 50A for storing audit logs, and in this embodiment, the audit log dedicated device 50A is associated with at least one particular logical unit in the storage apparatus 5.

Furthermore, in this embodiment, the audit log dedicated device 50A is associated with at least one particular file in the local file system in the NAS board 21 in the storage apparatus 5. The definition of the logical devices 50, the association between the logical devices 50 and the logical units, the association between the logical devices 50 and the audit log dedicated device(s) 50A, and the association between the particular file(s) in the NAS board 21 local file system and the audit log dedicated device(s) 50A are conducted in advance by, for example, the storage apparatus 5 administrator via, for example, the management interface 27.

The audit log data LD is data recording information indicating the occurrence of an audit event, such as an action of a user or a failure in the host 2 or NAS client host 6. The audit log data LD also records audit event-related information, such as the name of the user causing an audit event, the time when the audit event occurred, the result of the audit event, and the cause of the audit event. The audit log data LD is created by the audit log write programs 80 on the hosts 2, or the audit log write program 82 in the NAS client host 6, and sent to the storage apparatus 5 via the SAN 4 or the LAN 7.

The audit log data LD is temporarily held by the channel adapter 20 or the NAS board 21 in the cache memory 23 to, e.g., ensure efficient data transmission, and then written to the audit log dedicated device 50A via the disk control interface 15. The audit log data LD is written by the storage apparatus 5 to the audit log dedicated device 50A irrespective of the logical address in the logical unit designated by the audit log write program 80 in the host 2 or the audit log write program 82 in the NAS client host 6.

The audit log data LD is read from the cache memory 23 or the audit log dedicated device 50A by the channel adapter 20 or the NAS board 21 in response to a read request from the audit log management program 81 in the audit log management host 3, and sent to the audit log management program 81 via the SAN 4 or the LAN 7.

The audit log write program 80 is a program for recording audit events, for example, user actions, or failures in the hosts 2, as audit logs. The audit log write program 80 stores audit event-related information in audit log data LD, and sends a request to write the audit log data LD to the logical unit associated with the audit log dedicated device 50A using a SCSI command, and subsequently sends the audit log data LD.

The audit log write program 82 is a program for, for example, recording audit events, for example, user actions, or failures in the NAS client host 6. The audit log write program 82 stores audit-related information in audit log data LD, and sends a request to write the audit log data LD to the file associated with the audit log dedicated device 50A using the network file system client program 83, and subsequently sends the audit log data LD.

The audit log management program 81 is a program for a user, for example, an audit log management host 3 user, to perform an audit log reference operation like audit log data viewing, or an audit log management operation like search or extraction of audit log data, targeting the audit log data LD stored in the storage apparatus 5.

An audit log reference operation involves the audit log management program 81 sending a request to read audit log data LD from the logical unit associated with the audit log dedicated device 50A, to the channel adapter 20 using a SCSI command, and receiving the audit log data LD.

An audit log reference operation also involves the audit log management program 81 sending a request to read audit log data LD from the logical unit associated with the audit log dedicated device 50A, to the NAS board 21, and receiving the audit log data LD.

Furthermore, the audit log management program 81 performs an audit log data LD reference or management operation by sending an audit log management command to the audit log management service program 72 in the NAS board 21 using, for example, HTTP (Hyper Text Transfer Protocol).

The I/O request processing program 60 is a program that receives, from the hosts 2 or the audit log management host 2, access requests like those to write/read data to/from a certain logical address in a logical unit, and receives/sends data from/to the hosts 2 or the audit log management host 3 in accordance with the content of the requests.

The I/O request processing program 60, upon receipt of an access request from a host 2 or the audit log management host 3, refers to the logical device information table 62 and identifies the logical device in the storage apparatus 5 associated with the logical unit.

If the I/O request processing program 60 receives a data write request, and the request is directed to the logical unit associated with the audit log dedicated device 50A, it treats the write request as an audit log data LD write request.

Next, the I/O request processing program 60, based on the audit log access control information table 53 in the shared memory 24, confirms whether or not the write request was issued by a host authorized to write audit log data LD to the audit log dedicated device 50A.

The I/O request processing program 60 also writes the audit log data LD to the cache memory 23, and registers management information for the audit log addition program 61 to add the audit log data LD to the audit log dedicated device 50A, in the cache management information table in the shared memory 24.

The I/O request processing program 60 manages the audit log dedicated device 50A's audit log addition addresses in the audit log control information table 52 in the shared memory 24 so that, when registering information in the cache management information table 51, the audit log data LD can be written to the audit log dedicated device 50A irrespective of the logical address designated by the host 2 or the audit log management host 3.

Also, if the I/O request processing program 60 receives a data read request, and the read request is directed to the logical unit associated with the audit log dedicated device 50A, it treats the request as an audit log data LD read request.

Next, the I/O request processing program 60, based on the audit log access control information table 53 in the shared memory 24, confirms whether or not the read request is one issued by a host authorized to read audit log data LD from the audit log dedicated device 50A.

The I/O request processing program 60 also reads audit log data LD from the cache memory 23 or the audit log dedicated device 50A. The operation procedure for the I/O request processing program 60, the formats of the access requests received from the hosts 2 or the dedicated log management host 3, and the formats of the logical device information table 62, the cache management information table 51, the audit log control information table 52, and the audit log access control information table 53 will be described later.

The audit log addition program 61 is a program that adds audit log data LD written in the cache memory 23 to the audit log dedicated device 50A by referring to the cache management information table 51 in the shared memory 24, for example, every certain period of time. The format of the cache management information table 51 will be explained later.

The network file system service program 70 is a program that provides a data input/output interface using a network file system protocol, such as NFS, or CIFS protocol, and receives, from the audit log management program 81 or the network file system client program 83, operation requests such as those to read/write data from/to offset addresses in the files, and writes/reads data to/from the logical devices 50 in files in accordance with those operation requests.

The network file system service program 70, upon receipt of a file operation request from the audit log management program 81 or the network file system client program 83, identifies the file name and path name in the local file system in the NAS board 21 corresponding the designated file name.

If the network file system service program 70 receives a write request targeting a file, and the identified file path represents the path of the file associated with the audit log dedicated device 50A, it treats the write request as an audit log data LD write request.

Next, the network file system service program 70, based on the audit log access control information table 53 in the shared memory 24, confirms whether or not the write request is one issued by a host authorized to write audit log data LD to the audit log dedicated device 50A.

The network file system service program 70 writes the audit log data LD to the cache memory 23, and registers management information for writing the audit log data LD to the audit log dedicated device 50A in the cache management information table 51 in the shared memory 24.

Here, the network file system service program 70 manages the audit log dedicated device 50A's audit log addition addresses in the audit log control information table 52 in the shared memory 24 so that the audit log data LD can be added to the audit log dedicated device 50A irrespective of offset address designated by the network file system client program 83.

Also, if the network file system service program 70 receives a file read request, and the identified file path represents the path for the file associated with the audit log dedicated device 50A, it treats the read request as an audit log data LD read request.

Next, the network file system service program 70, based on the audit log access control information table 53 in the shared memory 24, confirms whether or not the read request is one issued by a host authorized to read audit log data LD from the audit log dedicated device 50A.

The network file system service program 70 also reads audit log data LD from the cache memory 23 or the audit log dedicated device 50A. The procedure for the network file system service program 70 operation, the formats of the access requests received from the audit log management program 81 or the network file system client program 83, and the formats of the audit log management information table 73, the cache management information table 51, the audit log control information table 52, and the audit log access control information table 53 will be described later.

The audit log management service program 72 provides an interface for the audit log management program 81 to perform audit log reference operations, such as audit log viewing, or audit log management operations, such as audit log data searching or extraction. Using HTTP, for example, the audit log management service program 72 receives an audit log management command from the audit log management program 81, and sends the result of the audit log reference or management operation back to the audit log management program 81. The format of the audit log management command, and the procedure for the audit log management service program 72 operation will be described later.

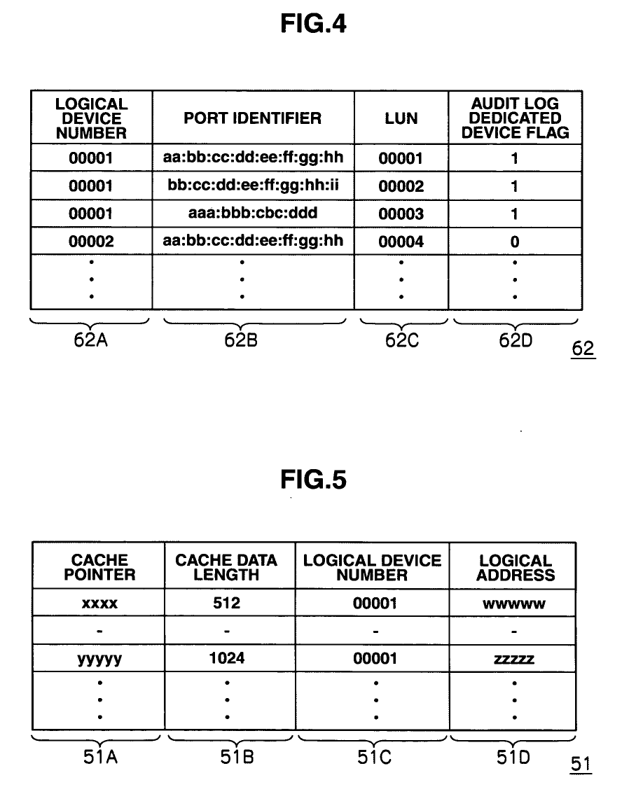

The logical device information table 62 includes the association between the logical devices 50 and the logical units, and association between the logical devices 50 and the audit log dedicated device(s) 50A, and is referred to by the I/O request processing program 60 upon receipt of an SCSI command to identify the logical device 50 associated with the logical unit, and judge whether or not the logical device 50 is an audit log dedicated device 50A. The content of the logical device information table 62 is defined or registered in advance by, for example, a storage apparatus 5 administrator. The format of the logical device information table 62 will be explained later with reference to FIG. 4.

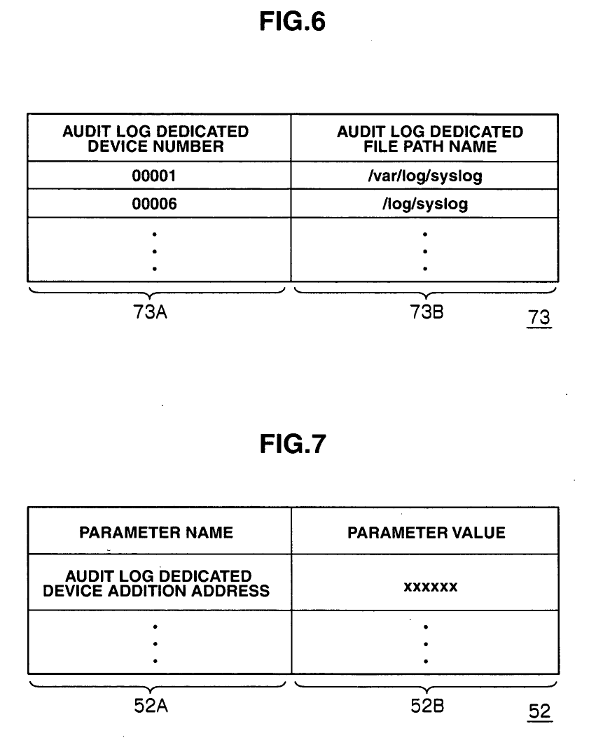

The audit log management information table 73 includes the association between the audit log dedicated device(s) 50A and the file(s) in the NAS board 21, and is referred to by the network file system service program 70 upon receipt of a file operation request to judge whether or not that request is a request to write/read audit log data LD to/from the audit log dedicated device 50A. The information included in the audit log management information table 73 is defined or registered in advance by, for example, a storage apparatus 5 administrator. The format of the audit log management information table 73 will be explained later with reference to FIG. 6.

The cache management information table 51 includes information like pointers indicating the locations of data written in the cache memory 23 and the logical devices 50 to which that data is to be written. The information included in the cache management information table 51 is written by the I/O request processing program 60 or the network file system service program 70 upon the storage apparatus 5 receiving a data write/read request from a host 2, the audit log management host 3, or the NAS client host 6, and is referred to by the audit log addition program 61, for example, when writing audit log data LD in the cache memory 23 to the audit log dedicated device 50A. The format of the cache management information table 51 will be explained later with reference to FIG. 5.

The audit log control information table 52 includes information on addresses in the audit log dedicated device 50A when writing audit log data LD in the cache memory 23 to the audit log dedicated device 50A. The information included in the audit log control information table 52 is referred to or updated by the I/O request processing program 60 or the network file system service program 70 when the storage apparatus 5 receives an audit log data LD write request from a host 2, the audit log management host 3 or the NAS client host 6. The format of the audit log control information table 52 will be explained later with reference to FIG. 7.

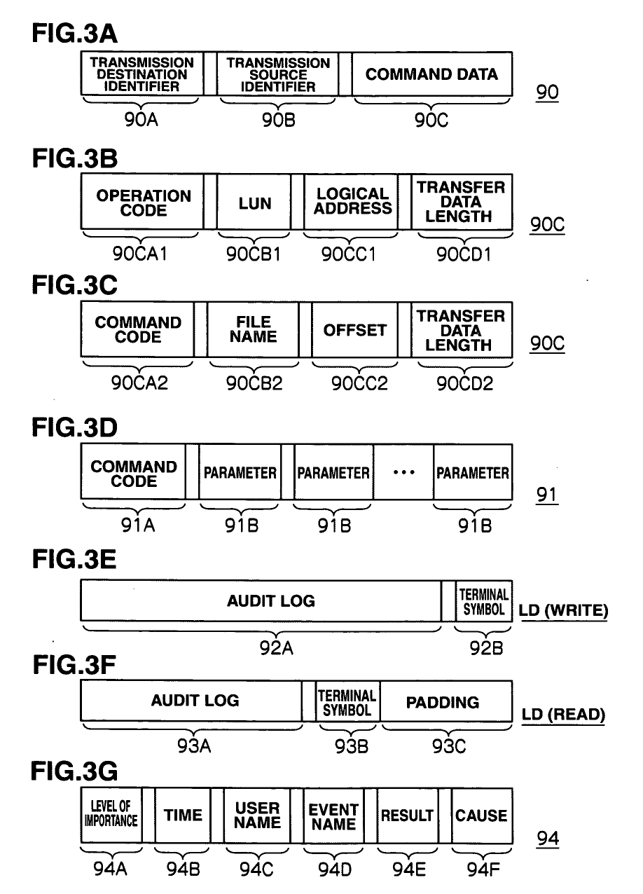

FIG. 3A shows an example structure for access request data 90 sent to the storage apparatus 5 when the audit log write program 80, the audit log management program 81, or the network file system client program 83 accesses data in the storage apparatus 5.

In the FIG. 3A example, a “TRANSMISSION DESTINATION IDENTIFIER” field 90A stores the identifier for the transmission destination of that access request data 90. For example, the WWN (World Wide Name) for the destination port in the FC-SAN, or the IP address value for the destination network interface in the IP-SAN or LAN is stored in this “TRANSMISSION DESTINATION IDENTIFIER” field 90.

A “TRANSMISSION SOURCE IDENTIFIER” field 90B stores the identifier for the transmission source of the access request data 90. The WWN for the transmission source port in the FC-SAN, or the IP address value for the transmission source network interface in the IP-SAN or LAN is stored in this “TRANSMISSION SOURCE IDENTIFIER” field 90B.

A “COMMAND DATA” field 90C stores command information indicating the content of this access request data 90. For example, a command frame according to SCSI standards, or one according to a network file system protocol, such as NFS or CIFS protocol, is stored in this “COMMAND DATA” field 90C.

FIG. 3B shows an example of command data 90C, which the audit log write program 80 or the audit log management program 81 sends to the storage apparatus 5, in the format of a command frame according to SCSI standards.

In the FIG. 3B example, an “OPERATION CODE” field 90CA1 stores a code value for a SCSI command. For example, a code value representing a write command or a read command is stored in this “OPERATION CODE” field 90CA1. Also, a “LUN” field 90CB1 stores the LUN for the logical unit that is the target of the SCSI command.

A “LOGICAL ADDRESS” field 90CC1 stores a value for an address for the location in a logical unit where the data is stored, which is the location in the logical unit where data is written/read to/from. A “TRANSFER DATA LENGTH” field 90CD1 stores the data length of the data that is to written/read.

FIG. 3C shows an example of the “COMMAND DATA” field 90C of the command data, which the audit log management program 81 or the network file system client program 83 sends to the storage apparatus 5, in the format of a command frame according to a network file system protocol, such as CIFS protocol.

In the FIG. 3C example, a “COMMAND CODE” field 90CA2 stores a code value for a command according to a network file system protocol. For example, a code value representing a write command or a read command is stored in this “COMMAND CODE” field 90CA2.

The “FILE NAME” field 90CB2 stores the name of the path for the file that is the target of the network file system protocol command, and the “OFFSET” field 90CC2 stores an address value indicating the location of the relevant data in the file, that is the location where the data is written to/read from. A “TRANSFER DATA LENGTH” field 90CD2 stores the data length of data that is to be written/read.

FIG. 3D shows an example of a data format of an audit log management command frame 91, which is sent from the audit log management program 81 to the audit log management service program 72 in the storage apparatus 5 using, for example, HTTP.

In the FIG. 3D example, a “COMMAND CODE” field 91A stores a code value according to the type of command (audit log management command) given by the audit log management program 81 to the audit log management service program 72. For example, a code value indicating the viewing, search, or extraction of an audit log is stored in this “COMMAND CODE” field 91A.

The “PARAMETER” field 91B stores a parameter for the audit log management command 91, for example, information like search keyword, an extraction time period, or extraction destination logical device number for the relevant audit log. A “0”, or one or more parameters are stored in this “PARAMETER” field 91B according to the type of command given by the audit log management program 81 to the audit log management service program 72.

FIGS. 3E and 3F show an example of a format for audit log data LD sent from a host 2 or the NAS client host 6 to the storage apparatus 5 following a write command sent from the host 2 or the NAS client host 6 to the storage apparatus 5, and an example of a format for audit log data LD sent from the storage apparatus 5 to the audit log management host 3 following a read command sent from the audit log management host 3 to the storage apparatus 5, respectively.

In these FIGS. 3E and 3F examples, an “AUDIT LOG” field 92A,93A stores the audit log data body. A “TERMINAL SYMBOL” field 92B,93B stores a symbol representing the end of the audit log data body (hereinafter referred to as “terminal symbol”). The terminal symbol is provided by, for example, the audit log write program 80, and as the terminal symbol, for example, the “NULL” string or line feed code is stored in this “TERMINAL SYMBOL” field 92B.

The “PADDING” field 93C stores padding data, for example, the “NULL” string, provided by the audit log write program 80 when, for example, the audit log data LD has a data length insufficient for SCSI standards.

FIG. 3G shows an example of the audit log data body 94 stored in audit log data LD.

In this FIG. 3G example, a “LEVEL OF IMPORTANCE” field 94A stores a code value representing the level of importance of an audit event detected in a host 2 or the NAS client host 6, and a “TIME” field 94B stores the time when the audit event was detected.

A “USER NAME” field 94C stores a letter string representing the name of the user causing the audit event detected in the host 2 or the NAS client host 6, and a “EVENT NAME” field 94D stores a letter string representing the content of the audit event.

A “RESULT” field 94E stores a letter string representing the result of the audit event detected in the host 2 or the NAS client host 6, and a “CAUSE” field 94F stores a letter string representing the cause of the audit event.

FIG. 4 shows an example structure for the logical device information table 62. The logical device information table 62 is a table for managing the logical devices defined in the storage apparatus 5, and includes “LOGICAL DEVICE NUMBER” fields 62A, “PORT IDENTIFIER” fields 62B, “LUN” fields 62C, and “AUDIT LOG DEDICATED DEVICE FLAG” fields 62D.

Each “LOGICAL DEVICE NUMBER” field 62A stores an identifier assigned to each logical device for uniquely identifying the logical device 50 in the storage apparatus 5.

Each “PORT IDENTIFIER” field 62B stores identification information for the connection port 32A or 32B connected to the relevant logical device 50 on the network (SAN) 4. For example, it stores the WWN of the connection port 32A or 32B if the network is a FC-SAN, and the IP address for the connection port 32A or 32B if the network is an IP-SAN. The identification information stored in the “PORT IDENTIFIER” field 62B is used by the I/O request processing program 60 to, when receiving an SCSI command from the audit log write program 80 or the audit log management program 81, identify the logical device 50 associated with the logical unit designated by that SCSI command.

Each “LUN” field 62C stores the LUN for the logical unit connected to the corresponding connection port 32A or 32B. The LUN stored in each “LUN” field 62 is used by the I/O request processing program 60 to, when receiving an SCSI command from the audit log write program 80 or the audit log management program 81, identify the corresponding logical device 50 based on that SCSI command.

Each “AUDIT LOG DEDICATED DEVICE FLAG” field 62D stores flag information representing whether or not the relevant logical device 50 is used as an audit log dedicated device 50A. More specifically, the “AUDIT LOG DEDICATED DEVICE FLAG” field 62D stores “1” if the logical device 50 is used as an audit log dedicated device 50A, and “0” if it is not.

In this embodiment, the logical device information table 62 stores the association between one audit log dedicated device 50A and one or more port identifiers, and makes it possible to store audit log data LD received via one or more connection ports 32A and 32B in one audit log dedicated device 50A. Associating one audit log dedicated device 50A with one or more logical units (LUN) makes it possible to change the logical unit associated with the audit log dedicated device 50A for each of the hosts 2.

FIG. 5 shows an example structure of the cache management information table 51. The cache management information table 51 is a table for managing data stored in the cache memory 23, and includes “CACHE POINTER” fields 51A, “CACHE DATA LENGTH” fields 51B, “LOGICAL DEVICE NUMBER” fields 51C, and “LOGICAL ADDRESS” fields 51D.

Each “CACHE POINTER” field 51A stores information on the pointer indicating the location in the cache memory 23 where the corresponding data is stored. Each “CACHE DATA LENGTH” field 51B stores the data length of the corresponding data, and each “LOGICAL DEVICE NUMBER” field 51C stores the logical device number for the logical device 50 to which the corresponding data is to be written. Each “LOGICAL ADDRESS” field 51D stores information on the address indicating the location in that logical device 50 where the corresponding data is to be written.

FIG. 6 shows an example structure of the audit log management information table 73. The audit log management information table 73 is a table for managing the audit log dedicated device 50A, and includes “AUDIT LOG DEDICATED DEVICE NUMBER” fields 73A, and “AUDIT LOG DEDICATED FILE PATH NAME” fields 73B.

Each “AUDIT LOG DEDICATED DEVICE NUMBER” field 73A stores identification information for uniquely identifying the corresponding audit log dedicated device 50A in the storage apparatus 5. Each “AUDIT LOG DEDICATED FILE PATH NAME” field 73B stores the path name of the file associated with the corresponding audit log dedicated device 50A in the local file system in the NAS board 21.

The network file system service program 70 receives access request data 90 (see FIGS. 3A and 3C) according to a network file system protocol from the audit log management program 81 or the network file system client program 83, and if the file in the local file system in the NAS board 21, which corresponds to the path name stored in the “FILE NAME” field 90CB2 of that access request data 90, is identified, and the path name of that file after the identification corresponds to the path name stored in the “AUDIT LOG DEDICATED FILE PATH NAME” field 73B, it judges that access request data 90 as a command targeting the corresponding audit log dedicated device 50A, and sends/receives the audit log data LD to/from the audit log dedicated device 50.

FIG. 7 show an example structure of the audit log control information table 52. The audit log control information table 52 is a table for managing the parameters necessary for the operation of the I/O request processing program 60 and the network file system service program 70, and includes “PARAMETER NAME” fields 52A and “PARAMETER VALUE” fields 52B.

Each “PARAMETER NAME” field 52A stores the identifier for a parameter, for example, an audit log dedicated device addition address, and each “PARAMETER VALUE” field 52B stores the parameter value for that parameter.

The audit log dedicated device addition address is an address that is referred to by the I/O request processing program 60 or the network file system service program 70 to indicate, to the audit log addition program 61, the location in the audit log dedicated device 50A audit log data LD in the cache memory 23 is to be written to, and is written in the corresponding “LOGICAL ADDRESS” field 51D in the cache management information table 51. Subsequently, the audit log dedicated device addition address is updated by the I/O request processing program 60 or the network file system service program 70 according to the data length of the audit log data LD in the cache memory 23.

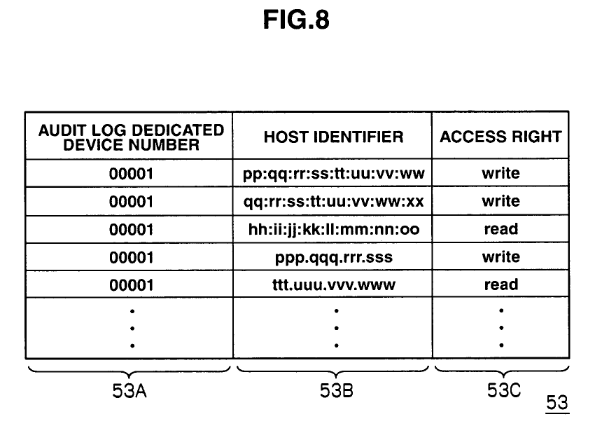

FIG. 8 shows an example structure for the audit log access control information table 53. The audit log access control information 53 is a table for managing access-related information for each audit log dedicated device 50A, and includes “AUDIT LOG DEDICATED DEVICE NUMBER” fields 53A, “HOST IDENTIFIER” fields 53B, and “ACCESS RIGHT” fields 53C.

Each “AUDIT LOG DEDICATED DEVICE NUMBER” field 53A stores identification information (logical device number), assigned to the relevant audit log dedicated device 50A, for uniquely identifying that audit log dedicated device 50A in the storage apparatus 5.

Each “HOST IDENTIFIER” field 53B stores identification information for a host (the host 2, the audit log management host 3 and/or the NAS client host 6) for which an access right has been set. More specifically, it stores, as identification information, the WWN for the relevant host if the network connecting the host 2 and the storage apparatus 5 is an FC-SAN, and the IP address if the network is an IP-SAN or LAN. It stores, as identification information, the node ID, the logical partition number, or the vender name or similar for the host 2 if the host 2 is a mainframe host.

Each “ACCESS RIGHT” field 53C stores the type of access right to the audit log dedicated device 50A with its logical device number stored in the corresponding “AUDIT LOG DEDICATED DEVICE NUMBER” field 53A, provided to the host (a host 2, the audit log management host 3, or an the NAS client host 6) with its identification information stored in the corresponding “HOST IDENTIFIER” field 53B. The type of access right may be “read,” which only permits reading of audit logs from the corresponding audit log dedicated device 50A, “write,” which only permits writing, or “read/write,” which permits both reading and writing.

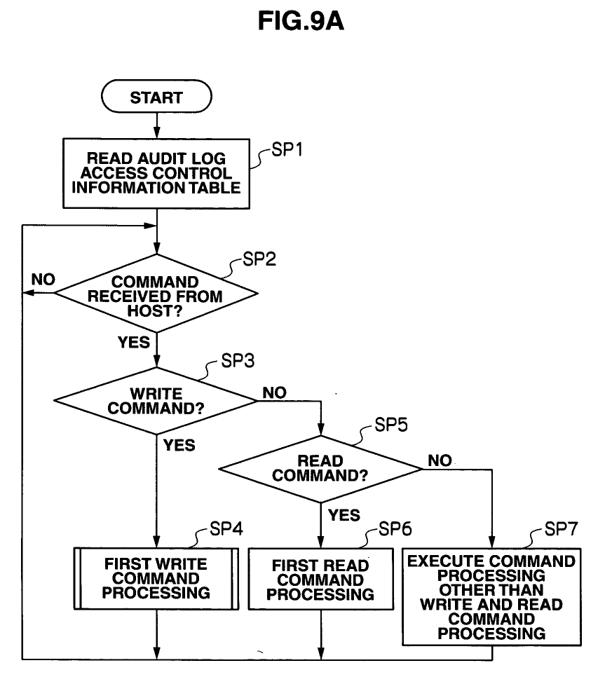

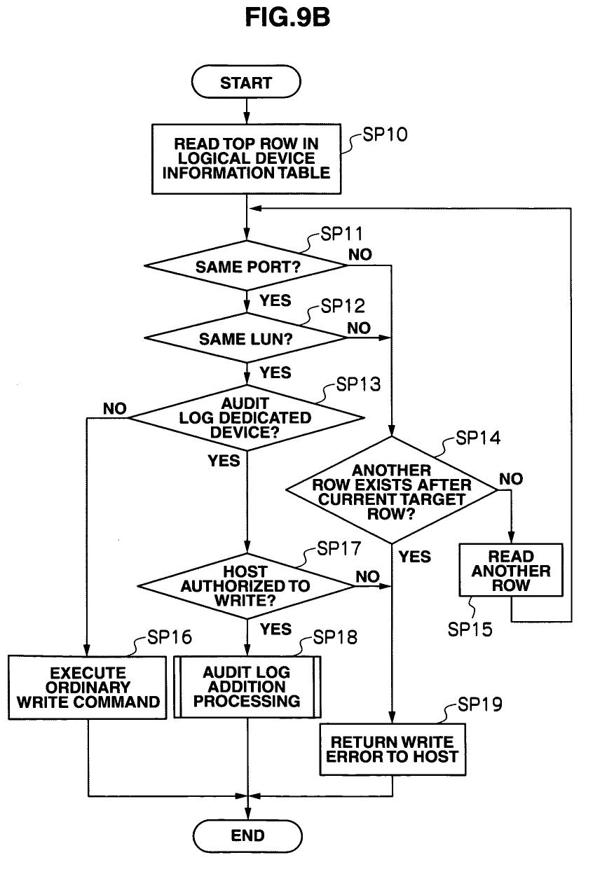

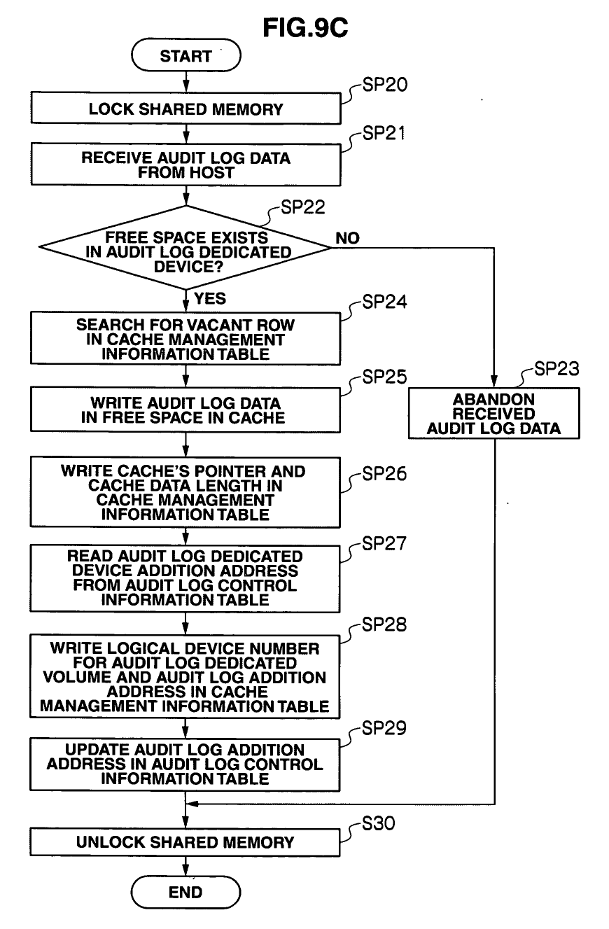

FIG. 9A is a flowchart showing an example of first command processing performed by the CPU 30 in the channel adapter 20 based on the I/O request processing program 60 upon receipt of access request data 90 (FIG. 3A) from a host 2, or the audit log management host 3.

The CPU 30, upon the activation of the channel adapter 20, starts the first command processing shown in FIG. 9A, and first, reads the audit log access control information table 53 (FIG. 8) from the shared memory 24 (SP1).

Subsequently, the CPU 30 waits to receive access request data 90 from a host 2 or the audit log management host 3 (SP2), and upon receipt of the access request data 90, judges whether or not the received command is a write command, based on the operation code stored in the “OPERATION CODE” field 90CA1 of that access request data 90 (SP3).

The CPU 30, upon an affirmative result in this judgment, executes the first write command processing (SP4), which will be described later with reference to FIG. 9B, and then returns to step SP2, and waits to receive the next access request data 90.

Meanwhile, the CPU 30, upon a negative result in the step SP3 judgment, judges whether or not that operation command is a read command (SP5).

The CPU 30, upon an affirmative result in this judgment, executes the first read command processing whereby the data designated by the access request data 90 is read from the designated location in the logical device 50 designated by the access request data 90 (SP6), like in ordinary SCSI read command processing, and then returns to step SP2, and waits to receive the next access request data 90.

The CPU 30, upon a negative result in the step SP5 judgment, executes the first command processing (other than the first write command processing and first read command processing) according to the command stored in the “OPERATION CODE” field 90CA1 of that access request data 90 (SP7), like in ordinary SCSI command processing. The CPU 30 then returns to SP2, and waits to receive the next access request data 90.

FIG. 9B is a flowchart showing the specific content of the first write command processing performed based on the I/O request processing program 60 at step SP4 in the first command processing described with reference to FIG. 9A.

The CPU 30, when proceeding to step SP4 in the first command processing (FIG. 9A), starts the first write command processing, and first reads information on the top row of the logical device information table 62 (FIG. 4) (SP10).

Then the CPU 30 judges whether or not the transmission source identifier stored in the “TRANSMISSION SOURCE IDENTIFIER” field 90A of the access request data 90 (FIG. 3A) received at step SP2 in the first command processing (FIG. 9A), and the port identifier stored in the “PORT IDENTIFIER” field 62B (FIG. 4) in the row read from the logical device information table 62 at step SP10 correspond to each other (SP11).

The CPU 30, upon an affirmative result at step SP11, judges whether or not the LUN stored in the “LUN” field 90CB1 of the access request data 90 (FIG. 3A) received at step SP2 in the first command processing (FIG. 9A), and the LUN stored in the “LUN” field 62C (FIG. 4) in the row read from the logical device information table 62 at step SP10 correspond to each other (SP12).

The CPU 30, upon an affirmative result at this judgment, judges whether or not the logical device 50 designated by the access request data 90 as the data write destination is an audit log dedicated device 50A (FIG. 2) by referring to the “AUDIT LOG DEDICATED DEVICE FLAG” field 62D in the row read from the logical device information table 62 at step SP10 (SP13).

The CPU 30, upon a negative result in this judgment, judges the write command stored in the access request data 90 received at step SP2 in the first command processing (FIG. 9A) as an ordinary write command, and stores the write data sent from the host 2 or the audit log management host 3 following that access request data 90 in the designated address location in the designated logical device 50 (SP16). The CPU 30 then terminates the first write command processing, and returns to the first command processing (FIG. 9A).

Meanwhile, the CPU 30, upon an affirmative result in the step SP13 judgment, judges whether or not the host 2 or the audit log management host 3 that sent that access request data 90 has the right to write data to the logical device 50 (audit log dedicated device 50A) by referring to the “ACCESS RIGHT” field 53C of the audit log access control information table 53 (FIG. 8) read at step SP1 (SP17).

More specifically, the CPU 30 reads information row by row from the audit log access control information table 53, and compares the logical device number stored in the “AUDIT LOG DEDICATED DEVICE NUMBER” field 53A in each of the read rows, and the logical device number identified at step SP12. If they correspond to each other, the CPU 30 compares the transmission source identifier stored in the “TRANSMISSION SOURCE IDENTIFIER” field 90B of the access request data 90 received at step SP2, and the “HOST IDENTIFIER” field 53B in that row of the audit log access control information table 53. If they correspond to each other, the CPU 30 judges whether or not the host 2 or the audit log management host 3 has the right to write data to the audit log dedicated device 50A by referring to the “ACCESS RIGHT” field 53C in that row (SP17).

The CPU 30, upon an affirmative result in the step SP17 judgment, executes the audit log addition processing (SP18), which will be described later with reference to FIG. 9C, and then terminates this first write command processing, and returns the first command processing.

Meanwhile, the CPU 30, upon an affirmative result in the step SP17 judgment, sends to the host 2 or the audit log management host 3 that sent that access request data 90 a write error to the effect that that host 2 or audit log management host 3 does not have the right to write data to that audit log dedicated device 50A (SP19), and then terminates the first write command processing and returns to the first command processing.

Meanwhile, the CPU 30, upon a negative result in the step SP11 or SP12 judgment, judges whether or not another row exists after the current target row in the logical device information table 62 (FIG. 4) (SP14).

The CPU 30, if another row exists, reads the information in that row from the logical device information table 62 (SP15), and repeats the same processing until it obtains an affirmative result at step SP12 or SP14 (until it detects the relevant logical devices 50 or completes the comparison with regard to all the rows in the logical device information table 62 (SP11 to SP15, to SP11).

The CPU 30 also, upon a negative result at step SP14, sends a write error to the effect that that host 2 or audit log management host 3 does not have the right to write data to that audit log dedicated device 50A to the host 2 or audit log management host 3 that sent that access request data 90 (SP19), and then terminates the first write command processing and returns to the first command processing (FIG. 9A).

FIG. 9C is a flowchart showing the specific content of processing performed by the CPU 30 at step SP18 in the aforementioned first write command processing (FIG. 9B).

The CPU 30, when proceeding to step SP18 in the first write command processing (FIG. 9B), starts the audit log addition processing shown in FIG. 9C, and first, locks the shared memory 24 (FIG. 1) so that no data will be written to the shared memory 24 (SP20), and then receives audit log data LD sent from the host 2 (SP21).

Subsequently, the CPU 30 confirms whether or not there is any free space in the audit log dedicated device 50A (SP22), and if there is, searches for a vacant row in the cache management information table 51 (FIG. 5) (SP24). More specifically, the CPU 30 reads the cache management information table 51 one by one from the top row; confirms whether or not a cache pointer is stored in the “CACHE POINTER” field 51A in each relevant row; and if no cache pointer is stored, judges that row as being vacant.

Next, the CPU 30 writes the audit log data LD received at step SP21 to the free space in the cache memory 23 (SP25), and then writes the address (pointer) in the cache memory 23 storage area where the audit log data LD has been written, and the data length of the audit log data LD in the “CACHE POINTER” field 51A and “CACHE DATA LENGTH” field 51B of the cache management information table 51 in the row detected at step SP24 (FIG. 5) (SP26)

The CPU 30 then stores a parameter value (address) stored in the “PARAMETER VALUE” field 52B corresponding to the “PARAMETER NAME” field 52A of the audit log control information table 52 (FIG. 7), which stores an audit log dedicated device addition address (the address from which addition is started when audit log data LD is added to the audit log dedicated device 50A) (SP27), and stores it in the vacant “LOGICAL ADDRESS” field 52D of the cache control information table 51 detected at step SP24. The CPU 30 also stores the logical device number identified at step SP12 (FIG. 9B) in the corresponding “LOGICAL DEVICE NUMBER” field 51C of the cache control information table 51 (SP28).

Subsequently, the CPU 30 updates the parameter value (address) stored in the “PARAMETER VALUE” field 52B corresponding to the “PARAMETER NAME” field 52A of the audit log control information table 52 (FIG. 7) where the audit log dedicated device addition address is stored to the value obtained by adding the audit log data length stored at step SP26 in the corresponding “CACHE DATA LENGTH” field 51B of the cache management information table 51, and the audit log dedicated device addition address read at step SP27 from the audit log control information table 52 (SP29).

The CPU 30 then unlocks the shared memory 24 (SP30), terminates the audit log addition processing, and returns to the first write command processing described above with reference to FIG. 9B.

The CPU 30, upon having confirmed at step SP22 that the audit log dedicated device 50A has no free space, abandons the received audit log data LD (SP23). Then, the CPU 30, after unlocking the shared memory 24 (SP30), terminates the audit log addition processing, and returns to the above first write command processing described above with reference to FIG. 9B.

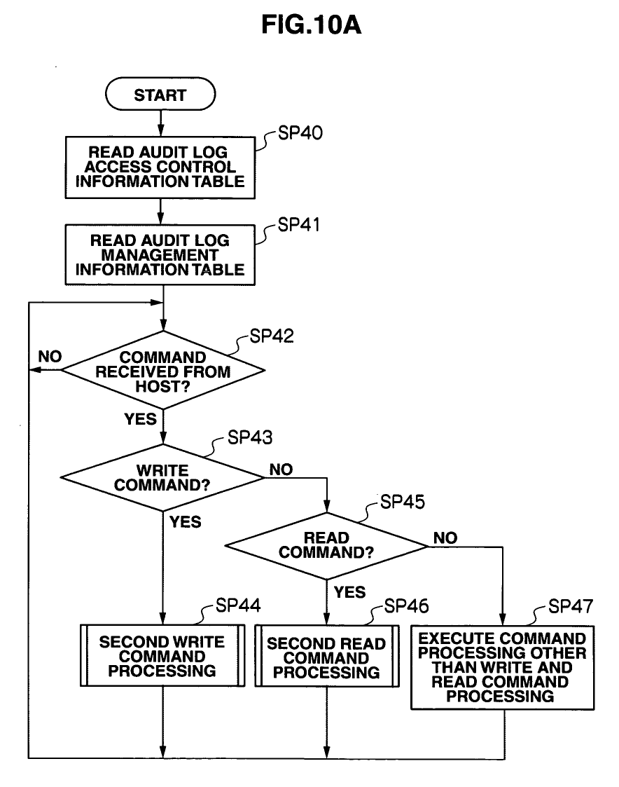

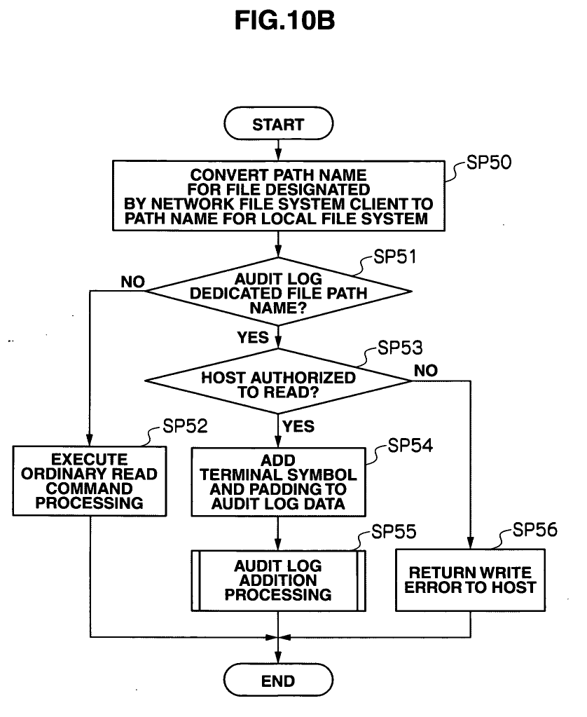

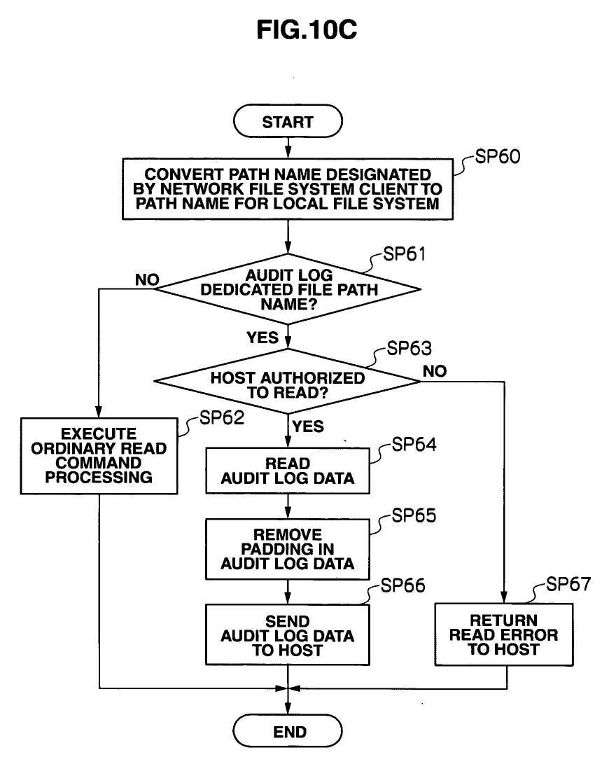

FIG. 10A is a flowchart showing an example of the second command processing performed by the CPU 40 on the NAS board 21 based on the network file system service program 70 (FIG. 2) upon receipt of access request data 90 (FIG. 3A) from the audit log management host 3 or the NAS client host 6.

The CPU 40, upon the activation of the NAS board 21, starts the second command processing shown in FIG. 10A, and first, reads the audit log access control information table 53 (FIG. 8) from the shared memory 24 (SP40), and then reads the audit log management information table 73 (FIG. 6) from the memory 31 (SP41).

Then, the CPU 40 waits to receive access request data 90 from the audit log management host 3 or the NAS client host 6 (SP42), and upon receipt of access request data 90, judges whether or not the received command is a write command, based on the command code stored in the “COMMAND CODE” field 90CA2 of that access request data 90 (SP43).

The CPU 40, upon an affirmative result in this judgment, executes the second write command processing (SP44), which will be described later with reference to FIG. 10B, and then returns to step SP42 and waits to receive the next access request data 90.

Meanwhile, the CPU 40, upon a negative result in the step SP43 judgment, judges whether or not the command is a read command (SP45).

The CPU 40, upon an affirmative result in this judgment, executes the second read command processing (SP43), which will be described later with reference to FIG. 10C, and then returns to step SP42 and waits to receive the next access request data 90.

The CPU 40, upon a negative result in this step SP45 judgment, executes, like in the first command processing, the command processing (other than the second write command processing (FIG. 10B) and the second read command processing (FIG. 10C)) according to the command stored in the “COMMAND CODE” field 90CA2 of that access request data 90 (SP47). The CPU 40 then returns to step SP42, and waits to receive the next access request data 90.

FIG. 10B is a flowchart showing the specific content of the second write command processing performed at step 44 in the second command processing described with reference to FIG. 10A.

The CPU 40, when proceeding to step SP44 in the second command processing, starts the second write command processing, and first, like in ordinary processing according to a network file system protocol like NFS or CIFS protocol, converts the path name stored in the “FILE NAME” field 90CB2 (FIG. 3C) of the access request data 90 received from the audit log management host 3 or the NAS client host 6 to the corresponding path name in the local file system in the NAS board 21 (SP50).

Subsequently, the CPU 40, based on the path name for the then-target file obtained at step SP50, judges whether or not the access request data 90 received from the audit log host 3 or the NAS client host 6 is a request for writing audit log data LD to the audit log dedicated device 50A (SP51).

More specifically, the CPU 40 reads the audit log management information table 73 (FIG. 6) row by row from the top row, and compares the path name in the local file system in the NAS board 21 obtained at step SP50, and the path name stored in the “AUDIT LOG DEDICATED FILE PATH NAME” field 73B in each relevant row to judge whether or not they correspond to each other. If they correspond to each other, the CPU 40 judges the access request data 90 as a request to write audit log data LD to the audit log dedicated device 50A with the logical device number stored in the “AUDIT LOG DEDICATED DEVICE NUMBER” field 73A in that row (SP51).

The CPU 40, upon a negative result in the step SP51 judgment, judges the access request data 90 to be an ordinary SCSI write command, and performs ordinary SCSI write command processing (SP52), and then terminates this second write command processing and returns to the second command processing (FIG. 10A).

Meanwhile, the CPU 40, upon an affirmative result in the step SP51 judgment, referring to the audit log access control information table 53 (FIG. 8) read at step SP40 (FIG. 10A), judges whether or not the audit log management 3 or NAS client host 6 that sent that access request data 90 has the right to write audit log data LD to that audit log dedicated device 50A (SP53).

More specifically, the CPU 40 reads information row by row from the audit log access control information table 53, and compares the logical device number identified at step SP 51 and the logical device number stored in the “AUDIT LOG DEDICATED DEVICE NUMBER” field 53A in each relevant row. If they correspond to each other, then the CPU 40 compares the identifier stored in the “TRANSMISSION SOURCE IDENTIFIER” field 90A of the access request data 90 received at step SP 42 with the identifier stored in the “HOST IDENTIFIER” field 53B in that row. If these identifiers correspond to each other, the CPU 40, referring to the “ACCESS RIGHT” field 53C in that row, judges whether or not the relevant audit log management host 3 or NAS client host 6 has the right to write audit log data LD to that audit log dedicated device 50A (SP53).

The CPU 40, upon an affirmative result in the step SP53 judgment, adds an terminal symbol (FIG. 3F) and padding data (FIG. 3F) to the audit log data LD subsequently sent from the audit log management host 3 or NAS client host 6 when needed (SP54).

The CPU 40 then executes the audit log addition processing described above with reference to FIG. 9C (SP55), and then terminates the second write command processing and returns to the second command processing.

Meanwhile, the CPU 40, upon a negative result in the SP53 judgment, sends a write error to the effect that that audit log management host 3 or NAS client host 6 does not have the right to write to that audit log dedicated device 50A to the audit log management host 3 or NAS client host 6 that sent that access request data 90 (SP56), and then terminates this second write command processing, and returns to the second command processing (FIG. 10A).

FIG. 10C is a flowchart showing the specific content of the processing performed by the CPU 40 at step SP46 in the above-described second command processing (FIG. 10A).

The CPU 40, when proceeding to step SP46 in the second command processing, starts the second read command shown in FIG. 10C, and first, like in ordinary processing in a network file system service like NFS or CIFS protocol, converts the path name stored in the “FILE NAME” field 90CB2 of the access request data 90 received from the audit log management host 3 to the corresponding path name in the local file system in the NAS board 21 (SP60).

Subsequently, the CPU 40, based on the then-target path name obtained at step SP50 in the second write command processing (FIG. 10B), judges whether or not the access request data 90 received from the audit log management host 3 is a request to read audit log data LD from the audit log dedicated device 50A (SP61).

More specifically, the CPU 40 reads the information in the audit log management information table 73 (FIG. 6) read at step SP41 (FIG. 10A) row by row from the top row, and compares the path name in the local file system in the NAS board 21 obtained at step SP60 and the path name stored in the “AUDIT LOG DEDICATED FILE PATH NAME” field 73B in each relevant row to judge whether or not they correspond to each other. If these path names correspond to each other, the CPU 40 judges that the access request data 90 is a request to read audit log data LD from the audit log dedicated device 50A with the logical device number stored in the “AUDIT LOG DEDICATED DEVICE NUMBER ” field 73A in that row (SP61).

The CPU 40, upon a negative result in the step SP61 judgment, judges the access request data 90 to be an ordinary SCSI read command, and performs ordinary data read processing (SP62), and then terminates the second read command processing, and returns to the second command processing (FIG. 10A).

Meanwhile, the CPU 40, upon an affirmative result in the step SP61 judgment, referring to the audit log access control information table 53 read at step SP40 (FIG. 10A), judges whether or not the audit log management host 3 that sent the access request data 90 has the right to read audit log data LD from that audit log dedicated device 50A (SP63).

More specifically, the CPU 40 reads information from the audit log access control information table 53 (FIG. 8) row by row, and compares the logical device number identified at step SP61 and the logical device number stored in the “AUDIT LOG DEDICATED DEVICE NUMBER” field 53A in each relevant row. If these logical device numbers correspond to each other, the CPU 40 judges whether or not the identifier stored in the “TRANSMISSION SOURCE IDENTIFIER” field 90A of the access request data 90 received at step SP42 (FIG. 10A) corresponds to the identifier stored in the “HOST IDENTIFIER” field 53B in that row. If these identifiers correspond to each other, the CPU 40, referring to the “ACCESS RIGHT” field 53C in that row, judges whether or not the audit log management host 3 has the right to read audit log data LD from that audit log dedicated device 50A.

The CPU 40, upon an affirmative result in this step SP63 judgment, reads the relevant audit log data LD from that audit log dedicated device 50A (SP64), and removes the terminal symbol (FIG. 3F) and padding data (FIG. 3F) attached to this audit log data LD (SP65).

Next, the CPU 40 sends the audit log data LD to the relevant audit log management host 3 (SP66), and then terminates this second read command processing and returns to the second command processing (FIG. 1A).

Meanwhile, the CPU 40, upon a negative result in the step SP63 judgment, sends a read error to the effect that the audit log management host 3 does not have the right to read audit log data LD from the audit log dedicated device 50A to the audit log management host 3 that sent the access request data 90 (SP67), and then terminates this second read command processing and returns to the second command processing.

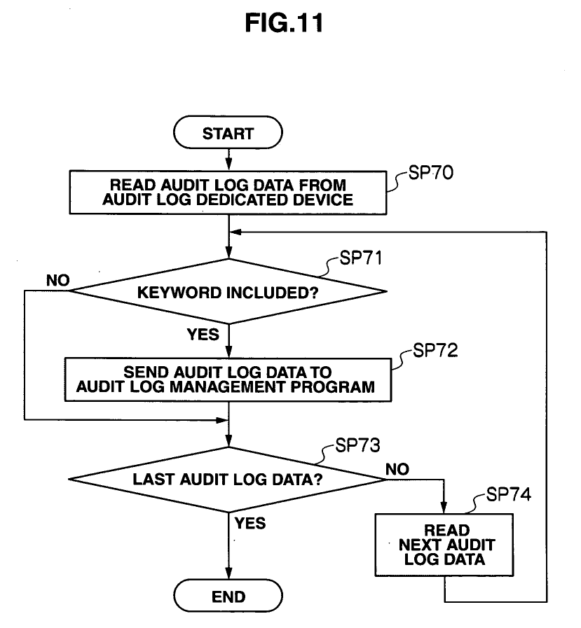

FIG. 11 is a flowchart showing the content of the processing performed by the CPU 40 on the NAS board 21 when it receives a request for extracting only audit log data LD including a particular keyword from the audit log dedicated device 50A.

At this time, the audit log management program 81 in the audit log management host 3 provides the NAS board 21 with an audit log management command frame 91 in the format described above with reference to FIG. 3D. This audit log management frame 91 stores an audit log data LD extraction instruction command in the “COMMAND CODE” field 91A, and an audit log extraction keyword in the foremost “PARAMETER” field 91B.

The CPU 40 on the NAS board 21, upon receipt of the audit log management command frame 91, executes the audit log extraction service processing shown in FIG. 11, based on the audit log management service program 72 (FIG. 2).

In other words, the CPU 40, upon receipt of that audit log management command frame 91, starts the audit log extraction service processing, and first reads the foremost audit log data LD including the terminal symbol and padding data from the audit log dedicated device 50A, from among the audit log data LD stored in the audit log dedicated device 50A (SP70).

Subsequently, the CPU 40 checks whether or not the then-read audit log data LD contains the extraction keyword stored in the “PARAMETER” field 91B in the then-received audit log management command frame 91, by means of pattern matching (SP71).

The CPU 40, upon judging that audit log data LD as containing the extraction keyword, judges whether or not that audit log data LD is the last one in the audit log data LD stored in the audit log dedicated device 50A, in other words, whether or not the same confirmation has been conducted for all the audit log data LD stored in the audit log dedicated device 50A (SP73).

The CPU 40, upon a negative result in this judgment, reads the audit log data LD that is the next confirmation target, from the audit log dedicated device 50A (SP74), and repeats the same processing until an affirmative result is obtained at step SP73 (SP71 to SP74, to SP71).

If the CPU 40 judges at step SP71 that audit log data LD as containing the extraction keyword, it removes the padding data from that audit log data LD, and then sends the audit log data LD to the audit log management program 81 (FIG. 2) (SP72).

Then the CPU 40 judges whether or not that audit log data LD is the last one in the audit log data LD stored in the audit log dedicated device 50A, in other words, whether or not the same confirmation has been conducted for all the audit log data LD stored in the audit log dedicated device 50A (SP73).

The CPU 40, upon a negative result in this judgment, reads the audit log data LD that is the next confirmation target, from the audit log dedicated device 50A (SP74), and then repeats the same processing until an affirmative result is obtained at step SP73 (SP71 to SP 74, to SP71).

The CPU 40, upon obtaining an affirmative result at step SP73 by having finished confirmation for all the audit log data LD stored in the audit log dedicated device 50A, terminates this audit log extraction service processing.

### (1-2) Effect of the Embodiment

As described above, in the storage system 1 according to this embodiment, the storage apparatus 5 writes the audit log data LD for the hosts 2 and the audit log management host 3 received via the connection ports 32A, 32B, and 42 to specific logical unit(s) associated with the audit log dedicated device(s) 50A, making it possible to collectively manage it in the audit log dedicated device(s) 50A. Also, in the storage system 1, the storage apparatus 5 writes the audit log data LD received according to a network file system protocol to the specific file(s) in the NAS board 21, making it possible to collectively manage it in the audit log dedicated device(s) 50A.

Accordingly, it is possible to collectively manage, in the audit log dedicated device(s) 50A, audit log data LD received by the storage apparatus 5 via the interfaces, the connection ports 32A, 32B, and 42, and the protocols, and as a result, the load on the syslog server can be reduced.

Also, irrespective of the logical address designated by a host (host 2, the audit log management host 3 or the NAS client host 6) or an offset address in a file, the storage apparatus 5's addition of audit log data LD to the audit log dedicated device(s) 50A makes it possible to prevent any audit log data LD alternation, and thus, the audit log data LD can be collectively and securely stored.

The audit log management service program 72 (FIG. 2)'s provision of interfaces for, e.g., audit log searches or extractions, makes it possible to support audit log management.

### (2) Second Embodiment

### (2-1) The Configuration of the Storage System According to the Embodiment

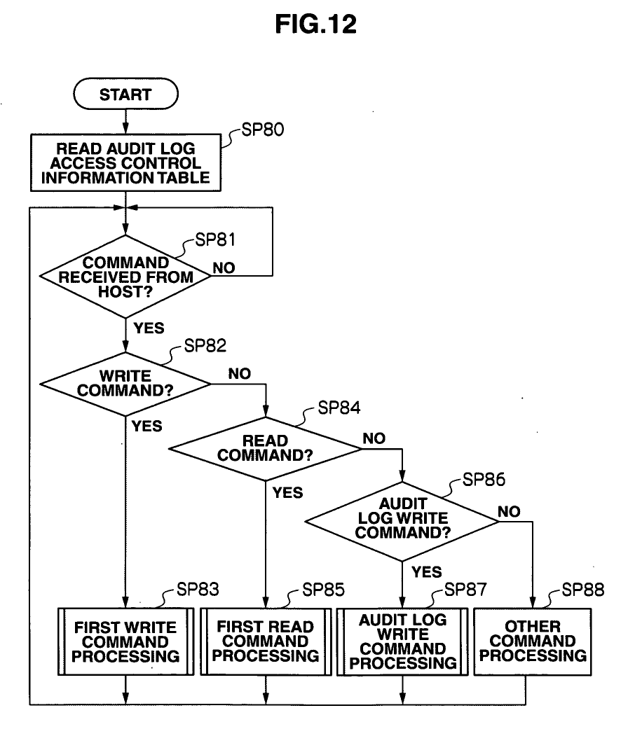

In FIGS. 1 and 2, 100 denotes a storage system according to the second embodiment. This storage system 100 differs from the storage system 1 according to the first embodiment in that: a particular audit log write command, which is different from an ordinary SCSI-standard write command, is used as an SCSI command; when the audit log write program 80 (FIG. 2) sends a request to write audit log data LD to an audit log dedicated device 50A, a code value for the audit log write command is set in the “OPERATION CODE” field 90CA1 (FIG. 3B); and the I/O request processing program 60 (FIG. 2) executes the command processing according to the third command processing shown in FIG. 12 instead of the first command processing described above with reference to FIG. 9A.

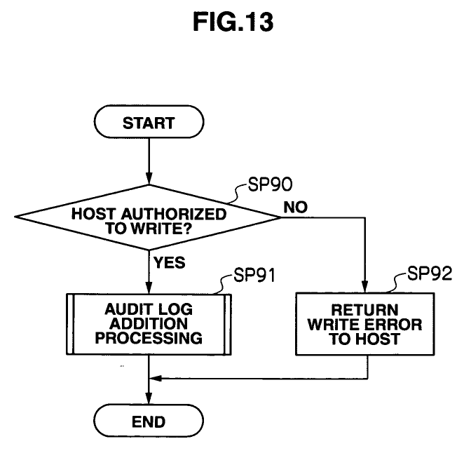

The storage system 100 according to this embodiment also differs from the storage system 1 according to the first embodiment in that: a particular audit log write command, which is different from an ordinary write command like one according to CIFS protocol, is used as a command according to a network file system protocol; when the audit log write program (FIG. 2) sends a request to write audit log data LD to an audit log device 50A, using the network file system client program 83 (FIG. 2), a code value for the audit log write command is set in the “COMMAND CODE” field 90CA2 (FIG. 3C); and the network file system service program 70 (FIG. 2) executes the command processing according to the fourth command processing shown in FIG. 13 instead of the second command processing described above with reference to FIG. 10A.

FIG. 12 is a flowchart showing an example of the third command processing executed by a CPU 30 in a channel adapter 102 in a storage apparatus 101 according to the second embodiment based on an I/O request processing program 104 (FIG. 2) stored in memory 103.

In this embodiment, the CPU 30, upon the activation of the channel adapter 102, starts the third command processing shown in FIG. 12, and performs the processing at steps SP80 to SP85 like in steps SP1 to SP6 in the first command processing described above with reference to FIG. 9A.

Meanwhile, the CPU 30, upon an negative result in the judgment at step SP84, judges whether or not the received command is an audit log write command employed in this embodiment, based on the operation code stored in the “OPERATION CODE” field 90CA1 of the access request data 90 received at step SP81 (SP86).

The CPU 30, upon an affirmative result in this judgment, executes audit log write command processing (SP87), which will be described later with reference to FIG. 13, and then returns to step SP81 and waits to receive the next access request data 90.

Meanwhile, the CPU 30, upon a negative result in the step SP86 judgment, executes command processing (other than write command processing, read command processing and audit log write command processing) like in ordinary SCSI command processing (SP88), and then returns to step SP81 and waits to receive the next access request data 90.

FIG. 13 is a flowchart showing the specific content of the third command processing executed based on the I/O request processing program 104 at step SP87 in the third command processing described above with reference to FIG. 12.

The CPU 30, when proceeding to step SP87 in the third command processing, starts the third write command processing, and first, referring to the audit log access control information table 53 (FIG. 8) read at step SP80 in the third command processing described above with reference to FIG. 12, confirms whether or not the host 2 that sent the access request data 90 has the right to write to the audit log dedicated device 50A. The specific content of the processing performed by the CPU 30 at this step is similar to step SP17 in the first write command processing described above with reference to FIG. 9B.

The CPU 30, upon an affirmative result in this judgment, executes the audit log addition processing described above with reference to FIG. 9C to add subsequent audit log data LD sent from the host 2 to the audit log dedicated device 50A, and then terminates the audit log write command processing, and returns to the third command processing (FIG. 12).

Meanwhile, the CPU 30 sends a write error to the effect that the host 2 does not have the right to write to the audit log dedicated device 50 to the host 2 that sent the access request data 90 (SP92), and then terminates the third write command processing and returns to the second command processing.

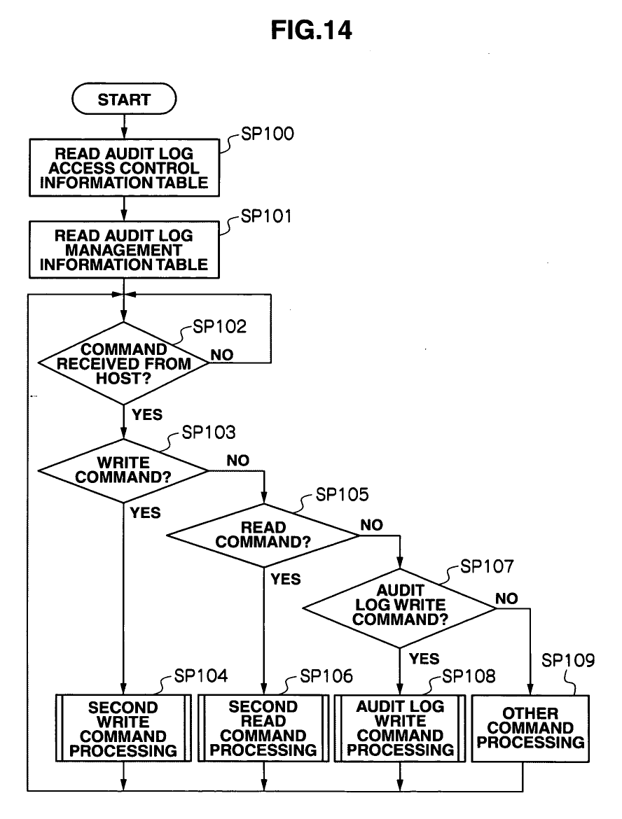

FIG. 14 is a flowchart showing an example of the fourth command processing executed by a CPU 40 on a NAS board 110 in the storage apparatus 101 according to the second embodiment based on a file system service program 112 (FIG. 2) stored in memory 111 when it receives access request data 90 (FIG. 3A) from the audit log management host 3 or the NAS client host 6.

The CPU 40, upon the activation of the NAS board 110, starts the fourth command processing shown in FIG. 14, and executes the processing at steps SP100 to SP106 like the processing at steps SP40 to SP46 in the second command processing described above with reference to FIG. 10A.

Meanwhile, the CPU 40, upon a negative result in the step SP106 judgment, judges whether or not the received command is an audit log write command employed in this embodiment, based on the command code stored in the “COMMAND CODE” field 90CA2 of the access request data 90 received at step SP102 (SP107).

The CPU 40, upon an affirmative result in this judgment, executes the audit log write command described above with reference to FIG. 13 (SP108), and then returns to step SP102 and waits to receive the next access request data 90.

Meanwhile, the CPU 40, upon a negative result in the step SP106 judgment, executes command processing (other than write command processing, read command processing and audit log write command processing) like in ordinary SCSI command processing (SP109), and then returns to step SP102, and waits to receive the next access request data 90.

### (2-2) Effect of the Embodiment

As described above, the storage system according to the second embodiment makes it possible to reduce the syslog server's load and collectively and securely store audit logs in the storage apparatus 101 by the storage apparatus 101 adding audit log data LD to the audit log dedicated device(s) 50A like it does in the first embodiment. The use of audit log write commands different from ordinary commands according to SCSI standards or network file system protocols eliminates the need to have particular logical units or files associated with the audit log dedicated device(s) 50A, like in the first embodiment, making it possible to simplify the settings for the storage apparatus 101, or reduce the content of the third or fourth write command processing based on the I/O request processing program 104 or the network file system service program 112.

### (3) Other Embodiments

The above-described first and second embodiments relate to where tables are used to hold information. However, the present invention is not limited to that, and various methods of holding information may be used.

The above-described first and second embodiments relate to the case where audit log data LD for the hosts 2, the audit log management host 3 and the NAS client host 6 is stored in the audit log dedicated device 50A set internally in the storage apparatus 1. However, the present invention is not limited to that case, and the audit log dedicated device 50A may be provided in an external storage apparatus connected to the storage apparatus 1, and audit logs sent from the hosts 2, etc., may be written/read to/from the audit log dedicated device 50A in the external storage apparatus under the control of the storage apparatus 1.

The present invention can be applied to a broad range of storage systems with various configurations.

While the invention has been described with respect to a limited number of embodiments, those skilled in the art, having benefit of this disclosure, will appreciate that other embodiments can be devised which do not depart from the scope of the invention as disclosed herein. Accordingly, the scope of the invention should be limited only by the attached claims.

What is claimed is:

1. A storage system, comprising:
one or more host apparatuses; and
a storage apparatus connected to the one or more host apparatuses via a network, the storage apparatus including one or more connection ports for connecting, to the network, one or more logical units defined in a storage area for storing data received from the one or more host apparatuses via the network, wherein:
a host apparatus, from among the one or more host apparatus, sends audit log data consisting of information indicating the occurrence of a predetermined audit event in the host apparatus to the storage apparatus via the network; and
the storage apparatus writes/reads the audit log data sent by the host apparatus to/from an audit log storage area consisting of an storage area for storing audit log data, defined in a logical unit from among the one or more logical units.

2. The storage system according to claim 1, wherein the storage apparatus includes a management interface for management for the storage apparatus, and defines the audit log storage area via the management interface.

3. The storage system according to claim 1, wherein the host apparatus sends the audit log data for the host apparatus to the storage apparatus as a write request targeting a particular logical unit from among the one or more logical units.

4. The storage system according to claim 3, wherein the storage apparatus writes the audit log data to the audit log storage area, irrespective of a write destination logical address for the audit log data designated by the write request sent from the host apparatus.

5. The storage system according to claim 1, wherein the storage apparatus stores the audit log data sent from the host apparatus via any one of the one or more connection ports in the audit log storage area.

6. The storage system according to claim 1, wherein:
the host apparatus sends the audit log data for the host apparatus to the storage apparatus as a write request targeting a particular file; and
the storage apparatus stores the audit log data sent from the host apparatus in the audit log storage area in the same format as that for the audit log data.

7. The storage system according to claim 6, wherein the storage apparatus writes the audit log data to the audit log storage area, irrespective of a write destination logical address for the audit log data designated by the write request sent from the host apparatus.

8. The storage system according to claim 1, wherein the storage apparatus allows a particular host apparatus, from among the one or more host apparatuses, to send a write/read request targeting the audit log storage area.

9. The storage system according to claim 1, wherein the storage apparatus provides the one or more host apparatuses with an audit log management interface for searching for and/or extracting the audit log data stored in the audit log storage area.

10. An audit log management method for managing audit log data consisting of information indicating the occurrence of a predetermined event in a host apparatus from among one or more host apparatuses in a storage system connecting the one or more host apparatuses and a storage apparatus via a network; the method comprising:
a first step of the host apparatus sending the audit log data for the host apparatus to the storage apparatus via the network; and
a second step of the storage apparatus writing/reading the audit log data sent from the host apparatus to/from an audit log storage area, consisting of an area for storing audit log data, defined in one or more logical units.

11. The audit log management method according to claim 10, comprising defining in advance the audit log storage area according to an external instruction given via a management interface for management for the storage apparatus before the first step.

12. The audit log management method according to claim 10, wherein the first step includes the host apparatus sending the audit log data for the host apparatus to the storage apparatus as a write request targeting a particular logical unit from among the one or more logical units.

13. The audit log management method according to claim 12, wherein the second step includes the storage apparatus writing the audit log data to the audit log storage area, irrespective of a write destination logical address for the audit log data designated by the write request sent from the host apparatus.

14. The audit log management method according to claim 10, wherein the second step includes the storage apparatus storing the audit log data sent from the host apparatus via any one of the connection ports in the audit log storage area.

15. The audit log management method according to claim 10, wherein:
the first step includes the host apparatus sending the audit log data for the host apparatus to the storage apparatus as a write request targeting a particular file; and
the second step includes the storage apparatus storing the audit log data sent from the host apparatus in the audit log storage area in the same format as that for the audit log data.

16. The audit log management method according to claim 15, wherein the second step includes the storage apparatus writing the audit log data to the audit log storage area, irrespective of a write destination logical address for the audit log data designated by the write request sent from the host apparatus.

17. The audit log management method according to claim 10, wherein the second step includes the storage apparatus allowing a particular host apparatus, from among the one or more host apparatuses, to send a write/read request targeting the audit log storage area.

18. The audit log management method according to claim 10, wherein the second step includes the storage apparatus providing the host apparatus with an audit log management interface for searching for and/or extracting the audit log data stored in the audit log storage area.
